(19) United States
(12) Patent Application Publication
(10) Pub. No.: US 2025/0225266 A1
(43) Pub. Date: Jul. 10, 2025

(54) METHODS AND APPARATUSES FOR MULTI-PARTY JOINT DATA PROCESSING TO PROTECT DATA PRIVACY

(71) Applicant: Alipay (Hangzhou) Information Technology Co., Ltd., Hangzhou (CN)

(72) Inventors: Wuqiong PAN, Hangzhou (CN); Haonan FENG, Hangzhou (CN); Zhongtian QIAN, Hangzhou (CN); Tianyi LI, Hangzhou (CN); Yongtao HU, Hangzhou (CN)

(21) Appl. No.: 18/871,391

(22) PCT Filed: Aug. 9, 2023
(86) PCT No.: PCT/CN2023/111956

§ 371 Date: Dec. 3, 2024

(30) Foreign Application Priority Data
Dec. 26, 2022 (CN) 202211694685.5

(51) Int. Cl. G06F 21/62

(52) U.S. Cl. CPC G06F 21/6218

(57) ABSTRACT

Embodiments of this specification provide methods and apparatuses for multi-party joint data processing to protect data privacy. The method is performed by the i^{th} party, and includes: acquiring two calculation fragments corresponding to the i^{th} party from three calculation fragments obtained by dividing calculation data; determining a first result fragment of a product result of the target data and the calculation data based on the fragment sum value, the specified fragment, and the two calculation fragments, and sending the first result fragment to a next participating party of the i^{th} party; and receiving a second result fragment of the product result from a previous participating party of the i^{th} party, where the second result fragment is determined by the previous participating party based on a fragment sum value and a specified fragment that are held by the previous participating party, and two calculation fragments corresponding to the previous participating party.

This specification claims priority to Chinese Patent Application No. 202211694685.5, filed with the China National Intellectual Property Administration on Dec. 26, 2022 and entitled “METHODS AND APPARATUSES FOR MULTI-PARTY JOINT DATA PROCESSING TO PROTECT DATA PRIVACY”, which is incorporated herein by reference in its entirety.

### TECHNICAL FIELD

This specification relates to the field of graph neural network technologies, and in particular, to methods and apparatuses for multi-party joint data processing to protect data privacy.

### BACKGROUND

Currently, due to concern about data privacy issues, a situation of data silos has become a serious problem. For example, in a model training scenario, there are three data owners in this scenario, which are respectively party A, party B, and party C. Party A, party B, and party C each hold a part of sample features of a training sample (for example, party A holds a first part of sample features of training sample A, party B holds a second part of sample features of training sample A, and party C holds a third part of sample features of training sample A) and a part of model data of a model to be trained. If two parties (for example, party A and party B) send data (a part of sample features of the training sample and a part of model data of the model to be trained) separately held by the two parties to a third party (for example, party C), one party performs joint data processing based on all data from the other two parties and its own data. In this process, party A and party B send data held by party A and party B to party C, resulting in exposure of the data of party A and party B.

Currently, increasingly strict privacy protection regulations hinder data sharing among a plurality of data owners. Therefore, how to provide a method for multi-party joint data processing to protect data privacy becomes an urgent problem to be resolved.

### SUMMARY

One or more embodiments of this specification provide methods and apparatuses for multi-party joint data processing to protect data privacy, to implement joint data processing on a premise of protecting privacy data of a plurality of parties, and reduce a calculation amount in a data processing process to a certain extent.

According to a first aspect, a method for multi-party joint data processing to protect data privacy is provided. The plurality of parties are three participating parties, target data is divided into three target fragments, and any i^{th} party in the plurality of parties holds a fragment sum value of two target fragments corresponding to the i^{th} party, and a specified fragment that meets a predetermined rule in the two target fragments. The method is performed by the i^{th} party, and includes:
acquiring two calculation fragments corresponding to the i^{th} party from three calculation fragments obtained by dividing calculation data;
determining a first result fragment of a product result of the target data and the calculation data based on the fragment sum value, the specified fragment, and the two calculation fragments, and sending the first result fragment to a next participating party of the i^{th} party; and
receiving a second result fragment of the product result from a previous participating party of the i^{th} party, where the second result fragment is determined by the previous participating party based on a fragment sum value and a specified fragment that are held by the previous participating party, and two calculation fragments corresponding to the previous participating party.

According to a second aspect, an apparatus for multi-party joint data processing to protect data privacy is provided. The plurality of parties are three participating parties, target data is divided into three target fragments, and any i^{th} party in the plurality of parties holds a fragment sum value of two target fragments corresponding to the i^{th} party, and a specified fragment that meets a predetermined rule in the two target fragments. The apparatus is deployed on the i^{th} party, and includes:
an acquisition module, configured to acquire two calculation fragments corresponding to the i^{th} party from three calculation fragments obtained by dividing calculation data;
a determining module, configured to: determine a first result fragment of a product result of the target data and the calculation data based on the fragment sum value, the specified fragment, and the two calculation fragments, and send the first result fragment to a next participating party of the i^{th} party; and
a receiving module, configured to receive a second result fragment of the product result from a previous participating party of the i^{th} party, where the second result fragment is determined by the previous participating party based on a fragment sum value and a specified fragment that are held by the previous participating party, and two calculation fragments corresponding to the previous participating party.

According to a third aspect, a non-transitory computer-readable storage medium is provided. The computer-readable storage medium stores a computer program, and when the computer program is executed in a computer, the computer is enabled to perform the method according to the first aspect.

According to a fourth aspect, a computing device is provided, including a memory and a processor. The memory stores executable code, and when the processor executes the executable code, the method according to the first aspect is implemented.

According to the methods and apparatuses for multi-party joint data processing to protect data privacy provided in the embodiments of this specification, the plurality of parties are three participating parties, target data is divided into three target fragments, and any i^{th} party in the plurality of parties holds a fragment sum value of two target fragments corresponding to the i^{th} party, and a specified fragment that meets a predetermined rule in the two target fragments. The i^{th} party acquires two calculation fragments corresponding to the i^{th} party from three calculation fragments obtained by dividing calculation data; determines a first result fragment of a product result of the target data and the calculation data based on the fragment sum value, the specified fragment, and the two calculation fragments, and sends the first result fragment to a next participating party of the i^{th} party; and receives a second result fragment of the product result from a previous participating party of the i^{th} party, where the second result fragment is determined by the previous participating party based on a fragment sum value and a specified fragment that are held by the previous participating party, and two calculation fragments corresponding to the previous participating party. In the above-mentioned process, the i^{th} party obtains only the first result fragment of the product result of the target data and the calculation data that is locally calculated by the i^{th} party and the second result fragment of the product result that is calculated by the previous participating party, and each party cannot acquire either plaintext of the target data and the calculation data or plaintext of the product result, so that joint data processing is implemented on the premise of protecting privacy data of the plurality of parties. In addition, the i^{th} party holds the fragment sum value of the two target fragments corresponding to the i^{th} party, and the specified fragment that meets the predetermined rule in the two target fragments. As such, when jointly calculating the product result of the target data and the calculation data with the other two participating parties, the i^{th} party can locally determine the first result fragment of the product result of the target data and the calculation data through only two times of multiplication based on the fragment sum value, the specified fragment, and the two calculation fragments, thereby reducing a calculation amount in a calculation process to a certain extent.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram illustrating a process in which three participating parties jointly perform data multiplication calculation, according to a related technology;

FIG. 2 is a schematic diagram illustrating an implementation scenario of an embodiment disclosed in this specification;

FIG. 3 is a schematic flowchart illustrating a method for multi-party joint data processing to protect data privacy, according to some embodiments; and

FIG. 4 is a schematic block diagram illustrating an apparatus for multi-party joint data processing to protect data privacy, according to some embodiments.

### DESCRIPTION OF EMBODIMENTS

The following describes in detail the technical solutions of the embodiments of this specification with reference to the accompanying drawings.

Embodiments of this specification disclose methods and apparatuses for multi-party joint data processing to protect data privacy. The following first describes application scenarios and technical concepts of the methods, which are specifically as follows:

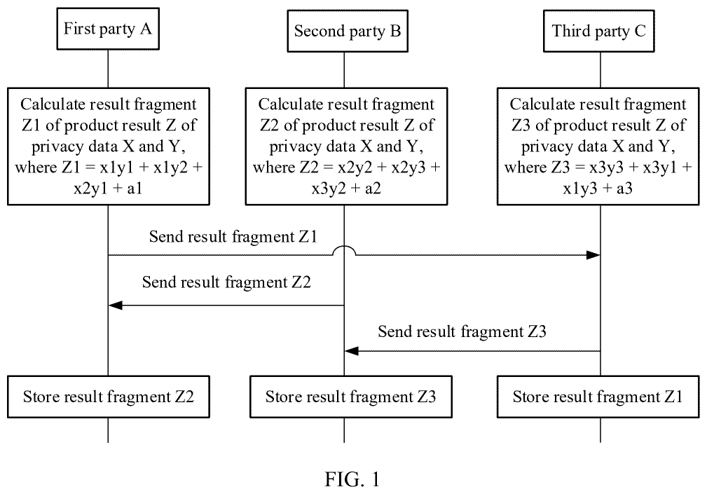

Currently, in a process in which a plurality of parties jointly perform data processing, the plurality of parties usually need to jointly perform data multiplication calculation. To protect privacy data security of each party, in a process in which the plurality of parties jointly perform data multiplication calculation, the plurality of parties can use the ABY3 protocol to jointly perform data multiplication calculation. The ABY3 protocol is a three-party MPC (multi-party secure computation/secure multi-party computation) protocol. Currently, as shown in FIG. 1, a process of jointly performing data multiplication calculation based on the ABY3 protocol is generally: For privacy data X and Y on which data multiplication calculation is performed, X and Y are separately divided into three parts (that is, three fragments), that is, X=x1+x2+x3, and Y=y1+y2+y3.

In a process of multiplication calculation on privacy data X and Y, there are three participating parties, which are respectively first party A, second party B, and third party C. Each party can hold two fragments of X and two fragments of Y. First party A can hold (x1, x2) (y1, y2), second party B can hold (x2, x3) (y2, y3), and third party C can hold (x3, x1) (y3, y1).

Then, multiplication calculation is performed on privacy data X and Y. Specifically, first party A calculates result fragment Z1 of product result Z of privacy data X and Y based on data (x1, x2) and (y1, y2) that are held by first party A, where result fragment Z1 can be represented by using the following formula: Z1=x1y1+x1y2+x2y1+a1. Second party B calculates result fragment Z2 of product result Z of privacy data X and Y based on data (x2, x3) and (y2, y3) that are held by second party B, where result fragment Z2 can be represented by using the following formula: Z2=x2y2+x2y3+x3y2+a2. Third party C calculates result fragment Z3 of product result Z of privacy data X and Y based on data (x3, x1) and (y3, y1) that are held by third party C, where result fragment Z3 can be represented by using the following formula: Z3=x3y3+x3y1+x1y3+a3. It can be understood that a1+a2+a3=0.

After obtaining result fragment Z1, first party A sends result fragment Z1 to third party C, and third party C stores result fragment Z1; after obtaining result fragment Z2, second party B sends result fragment Z2 to first party A, and first party A stores result fragment Z2; and after obtaining result fragment Z3, third party C sends result fragment Z3 to second party B, and second party B stores result fragment Z3 (alternatively, after obtaining result fragment Z1, first party A sends result fragment Z1 to second party B, and second party B stores result fragment Z1; after obtaining result fragment Z2, second party B sends result fragment Z2 to third party C, and third party C stores result fragment Z2; and after obtaining result fragment Z3, third party C sends result fragment Z3 to first party A, and first party A stores result fragment Z3). As such, each party can obtain two result fragments of the product result of privacy data X and Y corresponding to the party, and any two parties can jointly determine the product result of privacy data X and Y, or perform subsequent calculation based on the two result fragments of the product result of privacy data X and Y.

By using the above-mentioned process, multiplication calculation of privacy data X and Y is completed on a premise of protecting privacy data X and Y. In the above-mentioned process, each party needs to perform three times of multiplication calculation in a process of performing sequential multiplication calculation on privacy data X and Y.

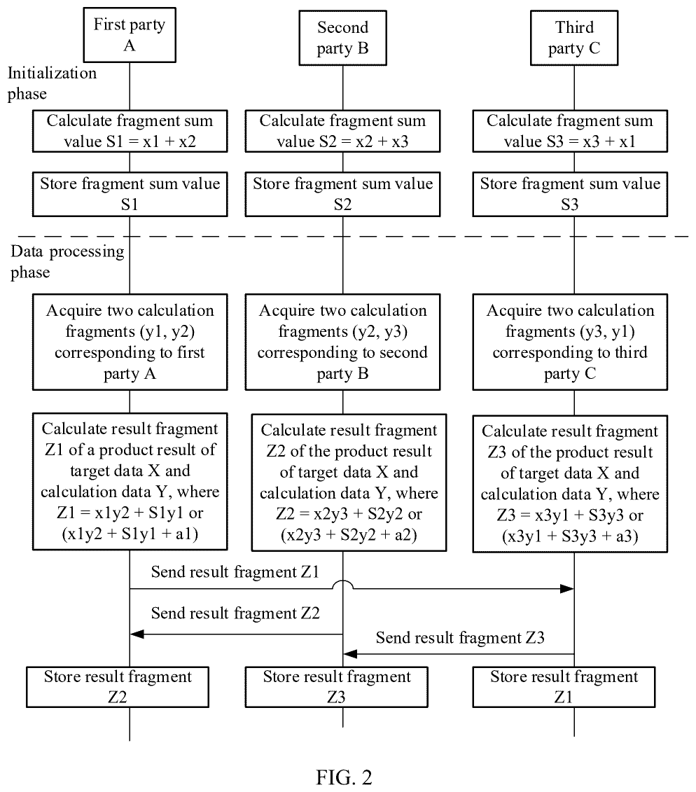

In view of the above-mentioned situation, to reduce calculation consumption to a certain extent in a process in which three parties jointly perform data multiplication calculation, the inventor proposes a method for multi-party joint data processing to protect data privacy. FIG. 2 shows a schematic diagram illustrating an implementation scenario of an embodiment disclosed according to this specification. In this implementation scenario, three participating parties are schematically shown, which are respectively first party A, second party B, and third party C. First party A, second party B, and third party C jointly perform data processing on target data X and calculation data.

In an example scenario, the three participating parties can be data owners. For example, the three participating parties are data owners that jointly train a target service model (for example, a model used for user classification, such as an XGBoost model), and the three participating parties can separately hold a part of sample feature data of a sample user for training the model (for example, first party A is an e-commerce platform and holds consumption record data of the sample user, second party B is a financial platform and holds credit data of the sample user, and third party C is an electronic payment platform and holds transaction records of the sample user), and separately hold a part of model data of the target service model. To ensure security of privacy data (sample feature data and model data) of each party, each party cannot directly send the data (plaintext) held by the party to the other two parties.

Correspondingly, the three participating parties can jointly divide each piece of sample feature data in all sample feature data of the sample user into three fragments, and divide each piece of model data in all model data into three fragments. Each party can hold two fragments corresponding to the party in the three fragments of each piece of sample feature data in all sample feature data of the sample user, and two fragments corresponding to the party in the three fragments of each piece of model data in all model data. Therefore, each party can hold fragments of all sample feature data of each sample user and fragments of model data, but cannot obtain plaintext data of the other parties. In addition, when one of the three participating parties is maliciously attacked, the other two participating parties can jointly restore original plaintext data (that is, sample feature data and model data).

It can be understood that, in a training process of the target service model, the sample feature data generally remains unchanged, and the model data needs to change according to the training process. In this embodiment, the sample feature data can be considered as target data X, and the model data can be considered as the calculation data.

In another example scenario, the three participating parties can be data processing parties, and at least two other data owners need the three participating parties to jointly perform data processing (for example, including data multiplication calculation) on data held by the at least two data owners. Correspondingly, to ensure security of privacy data of the data owners, the three participating parties can separately acquire two target fragments corresponding to each party in three target fragments of target data X (unchanged data in a calculation process) of the at least two data owners (and need to obtain two calculation fragments corresponding to each party in three calculation fragments of calculation data Y of the at least two data owners).

Correspondingly, each of the above-mentioned three participating parties can separately hold two target fragments corresponding to each party in the three target fragments (which are respectively first fragment x1, second fragment x2, and third fragment x3, as shown in FIG. 2) of target data X. As shown in FIG. 2, first party A can hold two target fragments (x1, x2) corresponding to first party A, second party B can hold two target fragments (x2, x3) corresponding to second party B, and third party C can hold two target fragments (x3, x1) corresponding to third party C.

In this embodiment, a process in which first party A, second party B, and third party C jointly perform data processing on target data X and the calculation data can include two phases: an initialization phase (a data preparation phase) and a data processing (data multiplication calculation) phase.

Specifically, in the initialization phase, each participating party calculates a fragment sum value of two target fragments of target data X that are held by the participating party, and stores the sum value. First party A calculates fragment sum value S1=x1+x2, and stores fragment sum value S1. Second party B calculates fragment sum value S2=x2+x3, and stores fragment sum value S2. Third party C calculates fragment sum value S3=x3+x1, and stores fragment sum value S3.

In an implementation, to save storage space, in a first manner, first party A can discard x2, and only retain (hold) x1 and S1; second party B can discard x3, and only retain x2 and S2; and third party C can discard x1, and only retain x3 and S3. In a second manner, first party A can alternatively discard x1, and only retain x2 and S1; second party B can discard x2, and only retain x3 and S2; and third party C can discard x3, and only retain x1 and S3.

Then, the data processing phase is entered. Specifically, each party can acquire two calculation fragments corresponding to the party in the three calculation fragments (which are respectively fourth fragment y1, fifth fragment y2, and sixth fragment y3, as shown in FIG. 2) of calculation data Y. First party A acquires two calculation fragments (y1, y2) corresponding to first party A, second party B acquires two calculation fragments (y2, y3) corresponding to second party B, and third party C acquires two calculation fragments (y3, y1) corresponding to third party C.

Each party determines a result fragment of a product result of target data X and calculation data Y based on the fragment sum value and the target fragment that are held by the party, and the two calculation fragments that are held by the party.

Specifically, in an embodiment, as shown in FIG. 2, in the above-mentioned first manner, that is, when first party A holds fragment sum value S1 and target fragment x1, second party B holds fragment sum value S2 and target fragment x2, and third party C holds fragment sum value S3 and target fragment x3, first party A determines result fragment Z1 of product result Z of target data X and calculation data Y based on fragment sum value S1 and target fragment x1 that are held by first party A, and two calculation fragments (y1, y2) held by first party A. Result fragment Z1 can be represented by using the following formula:

Result fragment Z1=x1y2+S1y1 or (x1y2+S1y1+a1).

Then, first party A sends the result fragment of first party A to a next participating party of first party A. If a predetermined transmission direction is to the left, the next participating party of first party A is third party C. If the predetermined transmission direction is to the right, the next participating party of first party A is second party B.

Second party B determines result fragment Z2 of the product result of target data X and calculation data Y based on fragment sum value S2 and target fragment x2 that are held by second party B, and two calculation fragments (y2, y3) held by second party B. Result fragment Z2 can be represented by using the following formula:

Result fragment Z2=x2y3+S2y2 or (x2y3+S2y2+a2).

Then, second party B sends the result fragment of second party B to a next participating party of second party B. If the predetermined transmission direction is to the left, the next participating party of second party B is first party A. If the predetermined transmission direction is to the right, the next participating party of second party B is third party C.

Third party C determines result fragment Z3 of the product result of target data X and calculation data Y based on fragment sum value S3 and target fragment x3 that are held by third party C, and two calculation fragments (y3, y1) held by third party C. Result fragment Z3 can be represented by using the following formula:

Result fragment Z3=x3y1+S3y3 or (x3y1+S3y3+a3). Herein, a1+a2+a3=0.

Then, third party C sends the result fragment of third party C to a next participating party of third party C. If the predetermined transmission direction is to the left, the next participating party of third party C is second party B. If the predetermined transmission direction is to the right, the next participating party of third party C is first party A.

In another embodiment, in the above-mentioned second manner, that is, when first party A holds fragment sum value S1 and target fragment x2, second party B holds fragment sum value S2 and target fragment x3, and third party C holds fragment sum value S3 and target fragment x1, first party A determines result fragment Z1 of product result Z of target data X and calculation data Y based on fragment sum value S1 and target fragment x2 that are held by first party A, and two calculation fragments (y1, y2) held by first party A. Result fragment Z1 can be represented by using the following formula:

Result fragment Z1=x2y1+S1y2 or (x2y1+S1y2+a1).

Then, first party A sends result fragment Z1 of first party A to a next participating party of first party A. If a predetermined transmission direction is to the left, the next participating party of first party A is third party C. If the predetermined transmission direction is to the right, the next participating party of first party A is second party B.

Second party B determines result fragment Z2 of the product result of target data X and calculation data Y based on fragment sum value S2 and target fragment x3 that are held by second party B, and two calculation fragments (y2, y3) held by second party B. Result fragment Z2 can be represented by using the following formula:

Result fragment Z2=x3y2+S2y3 or (x3y2+S2y3+a2).

Then, second party B sends result fragment Z2 of second party B to a next participating party of second party B. If the predetermined transmission direction is to the left, the next participating party of second party B is first party A. If the predetermined transmission direction is to the right, the next participating party of second party B is third party C.

Third party C determines result fragment Z3 of the product result of target data X and calculation data Y based on fragment sum value S3 and target fragment x1 that are held by third party C, and two calculation fragments (y3, y1) held by third party C. Result fragment Z3 can be represented by using the following formula:

Result fragment Z3=x1y3+S3y1 or (x1y3+S3y1+a3).

Then, third party C sends result fragment Z3 of third party C to a next participating party of third party C. If the predetermined transmission direction is to the left, the next participating party of third party C is second party B. If the predetermined transmission direction is to the right, the next participating party of third party C is first party A.

It can be understood that a process in which first party A determines the result fragment of first party A, a process in which second party B determines the result fragment of second party B, and a process in which third party C determines the result fragment of third party C can be simultaneously performed by the three parties.

As such, first party A, second party B, and third party C (three participating parties) jointly complete a product calculation process of target data X and calculation data Y. It can be understood that, when target data X remains unchanged, a process in which first party A obtains S1 through calculation, second party B obtains S2 through calculation, and third party C obtains S3 through calculation can be executed only once in the initialization phase. Then, after the data multiplication calculation phase is entered, in a process of locally calculating a corresponding result fragment, first party A, second party B, and third party C can obtain corresponding result fragments by performing only two times of multiplication. When multiplication calculation is performed by using target data X and a plurality of pieces of calculation data, multiplication calculation is performed only two times in a process in which multiplication calculation is performed on target data X and each piece of calculation data. Relative to the above-mentioned multiplication calculation process (a procedure shown in FIG. 1) in which calculation is performed three times in a related technology, ⅓ of a calculation amount can be saved in a process in which multiplication calculation is performed on target data X and a plurality of pieces of calculation data (a calculation amount in the initialization phase can be ignored, relative to the process in which multiplication calculation is performed on target data X and a plurality of pieces of calculation data). This reduces a calculation amount in a calculation process when implementing joint data processing on a premise of protecting privacy data of each party against leakage.

In an embodiment, the three participating parties can form a trusted-environment-based cryptographic system, that is, a TEE (Trusted Execution Environment, trusted execution environment) is set on all the three participating parties. Correspondingly, the method for multi-party joint data processing to protect data privacy provided in this embodiment of this specification runs in the TEE, to better improve security in a joint data processing process.

With reference to a specific embodiment, the following describes in detail the method for multi-party joint data processing to protect data privacy provided in this specification.

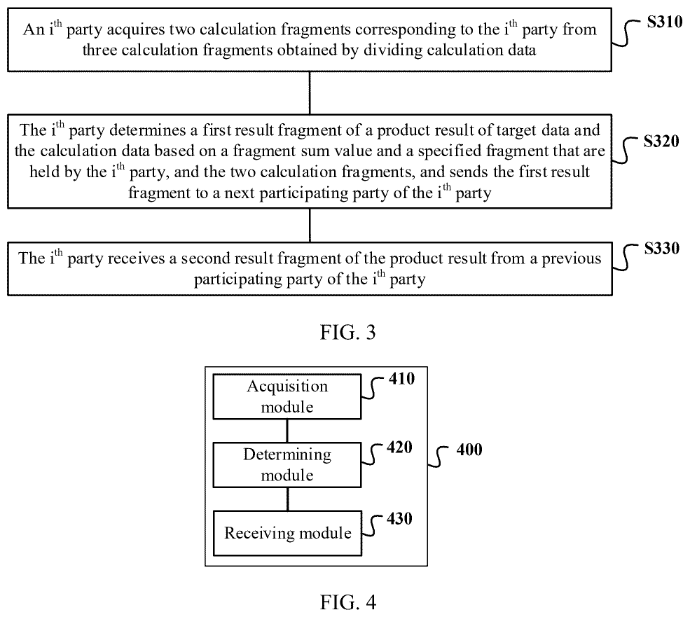

FIG. 3 shows a flowchart illustrating a method for multi-party joint data processing to protect data privacy, according to some embodiments of this specification. The plurality of parties are three participating parties (for example, including first party A, second party B, and third party C), and the three participating parties can be implemented by any apparatus, device, platform, device cluster, etc. having computing and processing capabilities. The three participating parties jointly process target data X and corresponding calculation data, that is, jointly calculate a product result of target data X and the calculation data.

It can be understood that a process in which the three participating parties perform multi-party joint data processing to protect data privacy can include two phases: an initialization phase (that is, a data preparation phase) and a data processing (that is, data multiplication calculation) phase. To make a layout clear, the following first describes the initialization phase.

In the initialization phase, target data X is divided into three target fragments (which are respectively, for example, first fragment x1, second fragment x2, and third fragment x3). Each party (for example, an i^{th} party) in the three participating parties can separately hold two target fragments corresponding to the party, where i can be 1, 2, and 3. For example, the three target fragments are cyclically arranged; and first party A holds first fragment x1 and second fragment x2 of target data X, second party B holds second fragment x2 and third fragment x3 of target data X, and third party C holds third fragment x3 and first fragment x1 of target data X.

Then, the i^{th} party calculates a sum value of the two target fragments corresponding to the i^{th} party, to obtain a fragment sum value corresponding to the i^{th} party, and stores the fragment sum value. Specifically, if the i^{th} party is first party A, first party A calculates a sum value of first fragment x1 and second fragment x2 (two corresponding target fragments) of first party A to obtain fragment sum value S1 corresponding to first party A, where S1=x1+x2; and stores fragment sum value S1. In this case, first party A stores first fragment x1, second fragment x2, and fragment sum value S1.

If the i^{th} party is second party B, second party B calculates a sum value of second fragment x2 and third fragment x3 (two corresponding target fragments) of second party B to obtain fragment sum value S2 corresponding to second party B, where S2=x2+x3; and stores fragment sum value S2. In this case, second party B stores second fragment x2, third fragment x3, and fragment sum value S2.

If the i^{th} party is third party C, third party C calculates a sum value of third fragment x3 and first fragment x1 (two corresponding target fragments) of third party C to obtain fragment sum value S3 corresponding to third party C, where S3=x3+x1; and stores fragment sum value S3. In this case, third party C stores third fragment x3, first fragment x1, and fragment sum value S3.

To save data storage space of each party, in an embodiment, the i^{th} party can delete a fragment other than a specified fragment in the two target fragments corresponding to the i^{th} party. The specified fragment meets a predetermined rule. Specifically, the specified fragment can be negotiated in advance by the three parties or can be specified in advance, and specified fragments of the parties are different from each other.

In an implementation, first fragment x1 in the two target fragments corresponding to first party A is a specified fragment, and correspondingly, second fragment x2 in the two target fragments corresponding to second party B and third fragment x3 in the two target fragments corresponding to third party C are specified fragments. In this case, to save data storage space, first party A can delete second fragment x2, and only retain first fragment x1 (specified fragment) and fragment sum value S1. Second party B can delete third fragment x3, and only retain second fragment x2 (specified fragment) and fragment sum value S2. Third party C can delete first fragment x1, and only retain third fragment x3 and fragment sum value S3.

In another implementation, second fragment x2 in the two target fragments corresponding to first party A is a specified fragment, and correspondingly, third fragment x3 in the two target fragments corresponding to second party B and first fragment x1 in the two target fragments corresponding to third party C are specified fragments. In this case, to save data storage space, first party A can delete first fragment x1, and only retain second fragment x2 (specified fragment) and fragment sum value S1. Second party B can delete second fragment x2, and only retain third fragment x3 (specified fragment) and fragment sum value S2. Third party C can delete third fragment x3, and only retain first fragment x1 and fragment sum value S3.

Then, the data multiplication calculation phase is entered. When the data multiplication calculation phase is entered, any i^{th} party in the plurality of parties that jointly perform data processing holds the fragment sum value of the two target fragments corresponding to the i^{th} party (for example, as mentioned above, first party A holds fragment sum value S1, second party B holds fragment sum value S2, and third party C holds fragment sum value S3), and the specified fragment that meets the predetermined rule in the two target fragments. It can be understood that, in the data processing phase, target data X is data that remains unchanged in the phase. Correspondingly, in the data processing phase, data that is about target data X and that is held by each party in the initialization phase, that is, the fragment sum value and the specified fragment, can be cyclically used.

As shown in FIG. 3, in the data processing phase, the method includes the following steps S310 to S330.

In step S310, the i^{th} party acquires two calculation fragments corresponding to the i^{th} party from three calculation fragments obtained by dividing calculation data.

The i^{th} party holds the two calculation fragments corresponding to the i^{th} party in the three calculation fragments obtained by dividing the calculation data. Specifically, first party A holds fourth fragment y1 and fifth fragment y2 in three calculation fragments (which are respectively fourth fragment y1, fifth fragment y2, and sixth fragment y3) of calculation data Y, second party B holds fifth fragment y2 and sixth fragment y3 of calculation data Y, and third party C holds sixth fragment y3 and fourth fragment y1 of calculation data Y.

The calculation data can be any data to be multiplied by target data X.

In an implementation, target data X can be a numerical value, a matrix, or a vector. Correspondingly, the calculation data can be a numerical value, a matrix, or a vector. When target data X (calculation data) is a matrix or a vector, a target fragment of target data X is a matrix or a vector of a same specification as target data X, and an element in the target fragment is a fragment of an element at a corresponding position in target data X.

Then, in step S320, the i^{th} party determines a first result fragment of a product result of the target data and the calculation data based on the fragment sum value and the specified fragment that are held by the i^{th} party, and the two calculation fragments, and sends the first result fragment to a next participating party of the i^{th} party.

In this step, the i^{th} party can determine the first result fragment of the product result of the target data and the calculation data based on the fragment sum value and the specified fragment that are held by the i^{th} party, and the two calculation fragments. Specifically, when the i^{th} party is first party A, first party A can determine result fragment Z1 (that is, the first result fragment) of product result Z of the target data and the calculation data based on fragment sum value S1 and the specified fragment (x1 or x2) that are held by first party A, and two calculation fragments y1 and y2.

Then, if a predetermined transmission direction is to the left, a next participating party of first party A is third party C. Correspondingly, after determining the first result fragment (that is, Z1), first party A sends the first result fragment (that is, Z1) to third party C. If the predetermined transmission direction is to the right, the next participating party of first party A is second party B. Correspondingly, after determining the first result fragment (that is, Z1), first party A sends the first result fragment (that is, Z1) to second party B.

When the i^{th} party is second party B, second party B can determine result fragment Z2 (that is, the first result fragment) of product result Z of the target data and the calculation data based on fragment sum value S2 and the specified fragment (x2 or x3) that are held by second party B, and two calculation fragments y2 and y3. Then, if the predetermined transmission direction is to the left, a next participating party of second party B is first party A. Correspondingly, after determining the first result fragment (that is, Z2), second party B sends the first result fragment (that is, Z2) to first party A. If the predetermined transmission direction is to the right, the next participating party of second party B is third party C. Correspondingly, after determining the first result fragment (that is, Z2), second party B sends the first result fragment (that is, Z2) to third party C.

When the i^{th} party is third party C, third party C can determine result fragment Z3 (that is, the first result fragment) of product result Z of the target data and the calculation data based on fragment sum value S3 and the specified fragment (x3 or x1) that are held by third party C, and two calculation fragments y3 and y1. Then, if the predetermined transmission direction is to the left, a next participating party of third party C is second party B. Correspondingly, after determining the first result fragment (that is, Z3), third party C sends the first result fragment (that is, Z3) to second party B. If the predetermined transmission direction is to the right, the next participating party of third party C is first party A. Correspondingly, after determining the first result fragment (that is, Z3), third party C sends the first result fragment (that is, Z3) to first party A.

It can be understood that, if the specified fragment held by the i^{th} party is different, a corresponding manner of determining the first result fragment of the product result of the target data and the calculation data is different. In an embodiment, the three target fragments are cyclically arranged; the specified fragment held by the i^{th} party is an i^{th} target fragment, and the fragment sum value held by the i^{th} party is an i^{th} sum value of the i^{th} target fragment and a next target fragment of the i^{th} target fragment; and the two calculation fragments corresponding to the i^{th} party are respectively an i^{th} calculation fragment and a next calculation fragment of the i^{th} calculation fragment. Correspondingly, step S320 can specifically include steps 11 and 12. In step 11, the i^{th} party calculates a sum value of a product of the i^{th} sum value and the i^{th} calculation fragment and a product of the i^{th} target fragment and the next calculation fragment. In step 12, the i^{th} party determines the first result fragment based on the sum value.

In this embodiment, when the i^{th} party is first party A, the specified fragment of the i^{th} party is a first target fragment, that is, above-mentioned first fragment x1; the i^{th} sum value of the i^{th} party is above-mentioned fragment sum value S1; and the i^{th} calculation fragment and the next calculation fragment of the i^{th} calculation fragment that correspond to the i^{th} party are respectively above-mentioned fourth fragment y1 and fifth fragment y2. Correspondingly, for first party A, first party A can calculate a sum value (that is, S1y1+x1y2) of a product of fragment sum value S1 and fourth fragment y1 and a product of first fragment x1 and fifth fragment y2, and then determine the first result fragment based on the sum value. In this case, the first result fragment is above-mentioned result fragment Z1.

When the i^{th} party is second party B, the specified fragment of the i^{th} party is a second target fragment, that is, above-mentioned second fragment x2; the i^{th} sum value of the i^{th} party is above-mentioned fragment sum value S2; and the i^{th} calculation fragment and the next calculation fragment of the i^{th} calculation fragment that correspond to the i^{th} party are respectively above-mentioned fifth fragment y2 and sixth fragment y3. Correspondingly, for second party B, second party B can calculate a sum value (that is, S2y2+x2y3) of a product of fragment sum value S2 and fifth fragment y2 and a product of second fragment x2 and sixth fragment y3, and then determine the first result fragment based on the sum value. In this case, the first result fragment is above-mentioned result fragment Z2.

When the i^{th} party is third party C, the specified fragment of the i^{th} party is a third target fragment, that is, above-mentioned third fragment x3; the i^{th} sum value of the i^{th} party is above-mentioned fragment sum value S3; and the i^{th} calculation fragment and the next calculation fragment of the i^{th} calculation fragment that correspond to the i^{th} party are respectively above-mentioned sixth fragment y3 and fourth fragment y1. Correspondingly, for third party C, third party C can calculate a sum value (that is, S3y3+x3y1) of a product of fragment sum value S3 and sixth fragment y3 and a product of third fragment x3 and fourth fragment y1, and then determine the first result fragment based on the sum value. In this case, the first result fragment is above-mentioned result fragment Z3.

Then, in an implementation, the i^{th} party can directly determine the calculated sum value as the first result fragment.

In another implementation, to better protect security of privacy data of each party, the determining the first result fragment based on the sum value in step 12 can specifically include: The i^{th} party obtains the first result fragment based on the sum value and a first random number fragment, where other two random number fragments corresponding to the first random number fragment are held by the other two participating parties, and are respectively used to calculate result fragments corresponding to the other two participating parties; and a sum value of the three random number fragments is 0.

In this implementation, the three participating parties respectively acquire random number fragments (a sum value of the three random number fragments is 0) corresponding to the three participating parties, and further obtain corresponding result fragments based on sum values respectively obtained by the three participating parties and the corresponding random number fragments. Such result fragments can better protect a product result.

Specifically, when the i^{th} party is first party A, first party A can calculate a sum value of the sum value of first party A and the first random number fragment (for example, a1), to obtain the first result fragment. Specifically, the first result fragment can be represented by using the following formula: Z1=S1y1+x1y2+a1. Correspondingly, the other two random number fragments (for example, a2 and a3) corresponding to first random number fragment a1 can be respectively held by second party B and third party C. For example, second party B holds random number fragment a2, which is used to calculate result fragment Z2 (Z2=S2y2+x2y3+a2); and third party C holds random number fragment a3, which is used to calculate result fragment Z3 (Z3=S3y3+x3y1+a3).

When the i^{th} party is second party B or third party C, for a process of determining the first result fragment based on the sum value calculated by second party B or third party C, references can be made to the process of determining the first result fragment when the i^{th} party is first party A. Details are omitted here for simplicity.

In an embodiment, when the product result of the target data and the calculation data is a matrix or a vector, the first random number fragment can be a matrix or a vector that has a same quantity of rows and/or a same quantity of columns as the product result. That the sum value of the three random number fragments is 0 can mean that a sum value of elements at each position in the first random number fragment and the other two random number fragments corresponding to the first random number fragment is 0. The other two random number fragments are held by the other two participating parties, and are respectively used to calculate the result fragments corresponding to the other two participating parties. When the product result of the target data and the calculation data is a numerical value, the first random number fragment is a numerical value, and that the sum value of the three random number fragments is 0 means that a sum value of the first random number fragment and the other two random number fragments corresponding to the first random number fragment is 0.

In another embodiment, the three target fragments are cyclically arranged; the specified fragment held by the i^{th} party can be an (i+1)^{th} target fragment, and the fragment sum value held by the i^{th} party is an i^{th} sum value of an i^{th} target fragment and the (i+1)^{th} target fragment; and the two calculation fragments corresponding to the i^{th} party are respectively an i^{th} calculation fragment and a next calculation fragment of the i^{th} calculation fragment. Correspondingly, step S320 can specifically include: determining the first result fragment based on a sum value of a product of the i^{th} sum value and the next calculation fragment and a product of the (i+1)^{th} target fragment and the i^{th} calculation fragment.

In this embodiment, when the i^{th} party is first party A, the specified fragment of the i^{th} party is a (1+1)^{th} target fragment, that is, above-mentioned second fragment x2; the i^{th} sum value of the i^{th} party is above-mentioned fragment sum value S1; and the i^{th} calculation fragment and the next calculation fragment of the i^{th} calculation fragment that correspond to the i^{th} party are respectively above-mentioned fourth fragment y1 and fifth fragment y2. Correspondingly, for first party A, first party A can calculate a sum value (that is, S1y2+x2y1) of a product of fragment sum value S1 and fifth fragment y2 and a product of second fragment x2 and fourth fragment y1, and then determine the first result fragment based on the sum value. In this case, the first result fragment is above-mentioned result fragment Z1.

When the i^{th} party is second party B, the specified fragment of the i^{th} party is a (2+1)^{th} target fragment, that is, above-mentioned third fragment x3; the i^{th} sum value of the i^{th} party is above-mentioned fragment sum value S2; and the i^{th} calculation fragment and the next calculation fragment of the i^{th} calculation fragment that correspond to the i^{th} party are respectively above-mentioned fifth fragment y2 and sixth fragment y3. Correspondingly, for second party B, second party B can calculate a sum value (that is, S2y3+x3y2) of a product of fragment sum value S2 and sixth fragment y3 and a product of third fragment x3 and fifth fragment y2, and then determine the first result fragment based on the sum value. In this case, the first result fragment is above-mentioned result fragment Z2.

When the i^{th} party is third party C, the specified fragment of the i^{th} party is a (3+1)^{th} target fragment, that is, above-mentioned first fragment x1; the i^{th} sum value of the i^{th} party is above-mentioned fragment sum value S3; and the i^{th} calculation fragment and the next calculation fragment of the i^{th} calculation fragment that correspond to the i^{th} party are respectively above-mentioned sixth fragment y3 and fourth fragment y1. Correspondingly, for third party C, third party C can calculate a sum value (that is, S3y1+x1y3) of a product of fragment sum value S3 and fourth fragment y1 and a product of first fragment x1 and sixth fragment y3, and then determine the first result fragment based on the sum value. In this case, the first result fragment is above-mentioned result fragment Z3.

Then, in an implementation, the i^{th} party can directly determine the calculated sum value as the first result fragment.

In another implementation, to better protect security of privacy data of each party, the i^{th} party obtains the first result fragment based on the sum value calculated by the i^{th} party and a first random number fragment, where other two random number fragments corresponding to the first random number fragment are held by the other two participating parties, and are respectively used to calculate result fragments corresponding to the other two participating parties; and a sum value of the three random number fragments is 0.

After the i^{th} party sends the first result fragment to the next participating party of the i^{th} party, in step S330, the i^{th} party receives a second result fragment of the product result from a previous participating party of the i^{th} party, where the second result fragment is determined by the previous participating party based on a fragment sum value and a specified fragment that are held by the previous participating party, and two calculation fragments corresponding to the previous participating party.

In an implementation, if the predetermined transmission direction is to the left, the previous participating party of the i^{th} party can be an (i+1)^{th} party. For example, when the i^{th} party is first party A, the previous participating party of the i^{th} party is second party B. Correspondingly, first party A can receive the second result fragment of the product result of target data X and calculation data Y from second party B (in this case, the second result fragment is above-mentioned Z2). When the i^{th} party is second party B, the previous participating party of the i^{th} party is third party C. Correspondingly, second party B can receive the second result fragment of the product result of target data X and calculation data Y from third party C (in this case, the second result fragment is above-mentioned Z3). When the i^{th} party is third party C, the previous participating party of the i^{th} party is first party A. Correspondingly, third party C can receive the second result fragment of the product result of target data X and calculation data Y from first party A (in this case, the second result fragment is above-mentioned Z1).

In another implementation, if the predetermined transmission direction is to the right, the previous participating party of the i^{th} party can be an (i−1)^{th} party. For example, when the i^{th} party is first party A, the previous participating party of the i^{th} party is third party C. Correspondingly, first party A can receive the second result fragment of the product result of target data X and calculation data Y from third party C (in this case, the second result fragment is above-mentioned Z3). When the i^{th} party is second party B, the previous participating party of the i^{th} party is first party A. Correspondingly, second party B can receive the second result fragment of the product result of target data X and calculation data Y from first party A (in this case, the second result fragment is above-mentioned Z1). When the i^{th} party is third party C, the previous participating party of the i^{th} party is second party B. Correspondingly, third party C can receive the second result fragment of the product result of target data X and calculation data Y from second party B (in this case, the second result fragment is above-mentioned Z2).

It can be understood that, by using the above-mentioned steps S310 to S330, the three participating parties can complete a multiplication calculation process of target data X and any one piece of calculation data. In this case, each party can separately hold two result fragments corresponding to the party in the three result fragments of the product result of the target data and the calculation data. Specifically, the i^{th} party can hold the first result fragment calculated by the i^{th} party, and the second result fragment of the product result that is received by the i^{th} party from the previous participating party of the i^{th} party. The previous participating party of the i^{th} party can hold the second result fragment calculated by the previous participating party of the i^{th} party, and hold a third result fragment of a next participating party of the i^{th} party, where the third result fragment is determined by the next participating party of the i^{th} party based on a fragment sum value and a specified fragment that are held by the next participating party of the i^{th} party, and two calculation fragments corresponding to the next participating party of the i^{th} party. In addition, the next participating party of the i^{th} party can hold the third result fragment calculated by the next participating party of the i^{th} party, and hold the first result fragment of the i^{th} party.

The three participating parties can separately hold two result fragments corresponding to each party in the three result fragments of the product result of the target data and the calculation data, so that when one of the three participating parties is maliciously attacked, the other two parties in the three participating parties can jointly determine plaintext of the product result of the target data and the calculation data. The three participating parties obtain the two result fragments corresponding to each party in the three result fragments of the product result of the target data and the calculation data, and can use the two result fragments corresponding to each party to jointly obtain the product result of the target data and the calculation data or continue to perform a subsequent data processing and calculation process.

In this embodiment, the i^{th} party obtains only the first result fragment of the product result of the target data and the calculation data that is locally calculated by the i^{th} party and the second result fragment of the product result that is calculated by the previous participating party of the i^{th} party, and each party cannot acquire either plaintext of the target data and the calculation data or plaintext of the product result, so that joint data processing can be implemented on the premise of protecting privacy data of the parties.

In addition, when target data X remains unchanged, a process of obtaining the fragment sum value by the i^{th} party in the initialization phase can be performed only once. After the data multiplication calculation phase is entered, in a process of locally calculating a corresponding result fragment by the i^{th} party, multiplication can be performed only two times to obtain the corresponding result fragment. When multiplication calculation is performed by using target data X and a plurality of pieces of calculation data, multiplication calculation is performed only two times in a process in which calculation is performed on target data X and each piece of calculation data. Relative to the above-mentioned multiplication calculation process (a procedure shown in FIG. 1) in which calculation is performed three times in a related technology, ⅓ of a calculation amount can be saved (a calculation amount in the initialization phase can be ignored, relative to a process in which multiplication calculation is performed on target data X and a plurality of pieces of calculation data).

Specific embodiments of this specification are described above, and other embodiments fall within the scope of the appended claims. In some cases, the actions or steps described in the claims can be performed in a sequence different from that in the embodiments and desired results can still be achieved. In addition, the process depicted in the accompanying drawings does not necessarily need a particular sequence or consecutive sequence to achieve the desired results. In some implementations, multitasking and parallel processing are possible or may be advantageous.

Corresponding to the above-mentioned method embodiment, an embodiment of this specification provides an apparatus 400 for multi-party joint data processing to protect data privacy. The plurality of parties are three participating parties, target data is divided into three target fragments, and any i^{th} party in the plurality of parties holds a fragment sum value of two target fragments corresponding to the i^{th} party, and a specified fragment that meets a predetermined rule in the two target fragments. The apparatus is deployed on the i^{th} party, and a schematic block diagram of the apparatus is shown in FIG. 4. The apparatus includes:
an acquisition module 410, configured to acquire two calculation fragments corresponding to the i^{th} party from three calculation fragments obtained by dividing calculation data;
a determining module 420, configured to: determine a first result fragment of a product result of the target data and the calculation data based on the fragment sum value, the specified fragment, and the two calculation fragments, and send the first result fragment to a next participating party of the i^{th} party; and
a receiving module 430, configured to receive a second result fragment of the product result from a previous participating party of the i^{th} party, where the second result fragment is determined by the previous participating party based on a fragment sum value and a specified fragment that are held by the previous participating party, and two calculation fragments corresponding to the previous participating party.

In an optional implementation, the three target fragments are cyclically arranged; the specified fragment held by the i^{th} party is an i^{th} target fragment, and the fragment sum value held by the i^{th} party is an i^{th} sum value of the i^{th} target fragment and a next target fragment of the i^{th} target fragment; and the two calculation fragments corresponding to the i^{th} party are respectively an i^{th} calculation fragment and a next calculation fragment of the i^{th} calculation fragment.

The determining module 420 includes:
a calculating unit (not shown in the figure), configured to calculate a sum value of a product of the i^{th} sum value and the i^{th} calculation fragment and a product of the i^{th} target fragment and the next calculation fragment; and
a determining unit (not shown in the figure), configured to determine the first result fragment based on the sum value.

In an optional implementation, the three target fragments are cyclically arranged; the specified fragment held by the i^{th} party is an (i+1)^{th} target fragment, and the fragment sum value held by the i^{th} party is an i^{th} sum value of an i^{th} target fragment and the (i+1)^{th} target fragment; and the two calculation fragments corresponding to the i^{th} party are respectively an i^{th} calculation fragment and a next calculation fragment of the i^{th} calculation fragment.

The determining module 420 is specifically configured to determine the first result fragment based on a sum value of a product of the i^{th} sum value and the next calculation fragment and a product of the (i+1)^{th} target fragment and the i^{th} calculation fragment.

In an optional implementation, the determining unit is specifically configured to obtain the first result fragment based on the sum value and a first random number fragment, where other two random number fragments corresponding to the first random number fragment are held by the other two participating parties, and are respectively used to calculate result fragments corresponding to the other two participating parties; and a sum value of the three random number fragments is 0.

In an optional implementation, the previous participating party of the i^{th} party further holds a third result fragment sent by the next participating party of the i^{th} party, and the third result fragment is determined by the next participating party based on a fragment sum value and a specified fragment that are held by the next participating party, and two calculation fragments corresponding to the next participating party.

In an optional implementation, the apparatus further includes:
an acquisition and storage module (not shown in the figure), configured to: acquire the two target fragments corresponding to the i^{th} party, calculate a sum value of the two target fragments to obtain the fragment sum value, and store the fragment sum value.

In an optional implementation, the apparatus further includes: a deletion module (not shown in the figure), configured to delete a fragment other than the specified fragment in the two target fragments.

The apparatus embodiments correspond to the method embodiments. For specific descriptions, references can be made to the descriptions in the method embodiments. Details are omitted here for simplicity. The apparatus embodiments are obtained based on the corresponding method embodiments, and have the same technical effects as the corresponding method embodiments. For specific descriptions, references can be made to the corresponding method embodiments.

An embodiment of this specification further provides a non-transitory computer-readable storage medium. The computer-readable storage medium stores a computer program, and when the computer program is executed in a computer, the computer is enabled to perform the method for multi-party joint data processing to protect data privacy provided in this specification.

An embodiment of this specification further provides a computing device, including a memory and a processor. The memory stores executable code, and when the processor executes the executable code, the method for multi-party joint data processing to protect data privacy provided in this specification is implemented.

The embodiments of this specification are described in a progressive manner. For the same or similar parts of the embodiments, mutual references can be made between the embodiments. Each embodiment focuses on a difference from other embodiments. In particular, the embodiments of the storage medium and the computing device are basically similar to the method embodiments, and therefore are described briefly. For related parts, references can be made to some descriptions in the method embodiments.

A person skilled in the art should be aware that in the above-mentioned one or more examples, functions described in the embodiments of this specification can be implemented by hardware, software, firmware, or any combination thereof. When being implemented by software, these functions can be stored in a computer-readable medium or transmitted as one or more instructions or code on a computer-readable medium.

The objectives, technical solutions, and beneficial effects of the embodiments of this specification are further described in detail in the specific implementations described above. It should be understood that the above-mentioned descriptions are merely specific implementations of the embodiments of this specification, and are not intended to limit the protection scope of this specification. Any modification, equivalent replacement, improvement, etc. made based on the technical solutions in this specification shall fall within the protection scope of this specification.

1. A method for multi-party joint data processing to protect data privacy, wherein a plurality of parties are three participating parties, target data is divided into three target fragments, and any i^{th} party in the plurality of parties holds a fragment sum value of two target fragments corresponding to an i^{th} party, and a specified fragment that meets a predetermined rule in the two target fragments; and the method is performed by the i^{th} party, and comprises:
acquiring two calculation fragments corresponding to the i^{th} party from three calculation fragments obtained by dividing calculation data;
determining a first result fragment of a product result of the target data and the calculation data based on the fragment sum value, the specified fragment, and the two calculation fragments, and sending the first result fragment to a next participating party of the i^{th} party; and
receiving a second result fragment of the product result from a previous participating party of the i^{th} party, wherein the second result fragment is determined by the previous participating party based on a fragment sum value and a specified fragment that are held by the previous participating party, and two calculation fragments corresponding to the previous participating party.

2. The method according to claim 1, wherein the three target fragments are cyclically arranged; the specified fragment held by the i^{th} party is an i^{th} target fragment, and the fragment sum value held by the i^{th} party is an i^{th} sum value of the i^{th} target fragment and a next target fragment of the i^{th} target fragment; the two calculation fragments corresponding to the i^{th} party are respectively an i^{th} calculation fragment and a next calculation fragment of the i^{th} calculation fragment; and
the determining a first result fragment of a product result of the target data and the calculation data comprises:
calculating a sum value of a product of the i^{th} sum value and the i^{th} calculation fragment and a product of the i^{th} target fragment and the next calculation fragment, and determining the first result fragment based on the sum value.

3. The method according to claim 1, wherein the three target fragments are cyclically arranged; the specified fragment held by the i^{th} party is an (i+1)^{th} target fragment, and the fragment sum value held by the i^{th} party is an i^{th} sum value of an i^{th} target fragment and the (i+1)^{th} target fragment; the two calculation fragments corresponding to the i^{th} party are respectively an i^{th} calculation fragment and a next calculation fragment of the i^{th} calculation fragment; and
the determining a first result fragment of a product result of the target data and the calculation data comprises:
determining the first result fragment based on a sum value of a product of the i^{th} sum value and the next calculation fragment and a product of the (i+1)^{th} target fragment and the i^{th} calculation fragment.

4. The method according to claim 2, wherein the determining the first result fragment based on the sum value comprises:
obtaining the first result fragment based on the sum value and a first random number fragment, wherein other two random number fragments corresponding to the first random number fragment are held by the other two participating parties, and are respectively used to calculate result fragments corresponding to the other two participating parties; and a sum value of the three random number fragments is 0.

5. The method according to claim 1, wherein the previous participating party of the i^{th} party further holds a third result fragment sent by the next participating party of the i^{th} party, and the third result fragment is determined by the next participating party based on a fragment sum value and a specified fragment that are held by the next participating party, and two calculation fragments corresponding to the next participating party.

6. The method according to claim 1, wherein the method further comprises:
acquiring the two target fragments corresponding to the i^{th} party, calculating a sum value of the two target fragments to obtain the fragment sum value, and storing the fragment sum value.

7. The method according to claim 6, further comprising deleting a fragment other than the specified fragment in the two target fragments.

8-14. (canceled)

15. A computing device, comprising a memory and a processor, wherein the memory stores executable code, and when the processor executes the executable code, the computing device is caused to implement a method for multi-party joint data processing to protect data privacy, wherein a plurality of parties are three participating parties, target data is divided into three target fragments, and any i^{th} party in the plurality of parties holds a fragment sum value of two target fragments corresponding to an i^{th} party, and a specified fragment that meets a predetermined rule in the two target fragments; and the method is performed by the i^{th} party, and the method comprises:
acquiring two calculation fragments corresponding to the i^{th} party from three calculation fragments obtained by dividing calculation data;
determining a first result fragment of a product result of the target data and the calculation data based on the fragment sum value, the specified fragment, and the two calculation fragments, and sending the first result fragment to a next participating party of the i^{th} party; and
receiving a second result fragment of the product result from a previous participating party of the i^{th} party, wherein the second result fragment is determined by the previous participating party based on a fragment sum value and a specified fragment that are held by the previous participating party, and two calculation fragments corresponding to the previous participating party.

16. The computing device according to claim 15, wherein the three target fragments are cyclically arranged; the specified fragment held by the i^{th} party is an i^{th} target fragment, and the fragment sum value held by the i^{th} party is an i^{th} sum value of the i^{th} target fragment and a next target fragment of the i^{th} target fragment; the two calculation fragments corresponding to the i^{th} party are respectively an i^{th} calculation fragment and a next calculation fragment of the i^{th} calculation fragment; and
the determining a first result fragment of a product result of the target data and the calculation data comprises:
calculating a sum value of a product of the i^{th} sum value and the i^{th} calculation fragment and a product of the i^{th} target fragment and the next calculation fragment, and determining the first result fragment based on the sum value.

17. The computing device according to claim 15, wherein the three target fragments are cyclically arranged; the specified fragment held by the i^{th} party is an (i+1)^{th} target fragment, and the fragment sum value held by the i^{th} party is an i^{th} sum value of an i^{th} target fragment and the (i+1)^{th} target fragment; the two calculation fragments corresponding to the i^{th} party are respectively an i^{th} calculation fragment and a next calculation fragment of the i^{th} calculation fragment; and
the determining a first result fragment of a product result of the target data and the calculation data comprises:
determining the first result fragment based on a sum value of a product of the i^{th} sum value and the next calculation fragment and a product of the (i+1)^{th} target fragment and the i^{th} calculation fragment.

18. The computing device according to claim 16, wherein the determining the first result fragment based on the sum value comprises:
obtaining the first result fragment based on the sum value and a first random number fragment, wherein other two random number fragments corresponding to the first random number fragment are held by the other two participating parties, and are respectively used to calculate result fragments corresponding to the other two participating parties; and a sum value of the three random number fragments is 0.

19. The computing device according to claim 15, wherein the previous participating party of the i^{th} party further holds a third result fragment sent by the next participating party of the i^{th} party, and the third result fragment is determined by the next participating party based on a fragment sum value and a specified fragment that are held by the next participating party, and two calculation fragments corresponding to the next participating party.

20. The computing device according to claim 15, wherein the computing device is further caused to:
acquire the two target fragments corresponding to the i^{th} party, calculate a sum value of the two target fragments to obtain the fragment sum value, and store the fragment sum value.

21. The computing device according to claim 20, wherein the computing device is further caused to delete a fragment other than the specified fragment in the two target fragments.

22. A non-transitory computer-readable storage medium, wherein the computer-readable storage medium stores a computer program, and when the computer program is executed on a computer, the computer is enabled to perform a method for multi-party joint data processing to protect data privacy, wherein a plurality of parties are three participating parties, target data is divided into three target fragments, and any i^{th} party in the plurality of parties holds a fragment sum value of two target fragments corresponding to an i^{th} party, and a specified fragment that meets a predetermined rule in the two target fragments; and the method is performed by the i^{th} party, and the method comprises:
acquiring two calculation fragments corresponding to the i^{th} party from three calculation fragments obtained by dividing calculation data;
determining a first result fragment of a product result of the target data and the calculation data based on the fragment sum value, the specified fragment, and the two calculation fragments, and sending the first result fragment to a next participating party of the i^{th} party; and
receiving a second result fragment of the product result from a previous participating party of the i^{th} party, wherein the second result fragment is determined by the previous participating party based on a fragment sum value and a specified fragment that are held by the previous participating party, and two calculation fragments corresponding to the previous participating party.

23. The non-transitory computer-readable storage medium according to claim 22, wherein the three target fragments are cyclically arranged; the specified fragment held by the i^{th} party is an i^{th} target fragment, and the fragment sum value held by the i^{th} party is an i^{th} sum value of the i^{th} target fragment and a next target fragment of the i^{th} target fragment; the two calculation fragments corresponding to the i^{th} party are respectively an i^{th} calculation fragment and a next calculation fragment of the i^{th} calculation fragment; and
the determining a first result fragment of a product result of the target data and the calculation data comprises:
calculating a sum value of a product of the i^{th} sum value and the i^{th} calculation fragment and a product of the i^{th} target fragment and the next calculation fragment, and determining the first result fragment based on the sum value.

24. The non-transitory computer-readable storage medium according to claim 22, wherein the three target fragments are cyclically arranged; the specified fragment held by the i^{th} party is an (i+1)^{th} target fragment, and the fragment sum value held by the i^{th} party is an i^{th} sum value of an i^{th} target fragment and the (i+1)^{th} target fragment; the two calculation fragments corresponding to the i^{th} party are respectively an i^{th} calculation fragment and a next calculation fragment of the i^{th} calculation fragment; and
the determining a first result fragment of a product result of the target data and the calculation data comprises:
determining the first result fragment based on a sum value of a product of the i^{th} sum value and the next calculation fragment and a product of the (i+1)^{th} target fragment and the i^{th} calculation fragment.

25. The non-transitory computer-readable storage medium according to claim 23, wherein the determining the first result fragment based on the sum value comprises:
obtaining the first result fragment based on the sum value and a first random number fragment, wherein other two random number fragments corresponding to the first random number fragment are held by the other two participating parties, and are respectively used to calculate result fragments corresponding to the other two participating parties; and a sum value of the three random number fragments is 0.

26. The non-transitory computer-readable storage medium according to claim 22, wherein the previous participating party of the i^{th} party further holds a third result fragment sent by the next participating party of the i^{th} party, and the third result fragment is determined by the next participating party based on a fragment sum value and a specified fragment that are held by the next participating party, and two calculation fragments corresponding to the next participating party.

27. The non-transitory computer-readable storage medium according to claim 22, wherein the processor is further caused to:
acquire the two target fragments corresponding to the i^{th} party, calculate a sum value of the two target fragments to obtain the fragment sum value, and store the fragment sum value.

28. The non-transitory computer-readable storage medium according to claim 22, wherein the processor is further caused to delete a fragment other than the specified fragment in the two target fragments.
